(19) United States
(12) Patent Application Publication
(10) Pub. No.: US 2016/0277535 A1
(43) Pub. Date: Sep. 22, 2016

(54) SYSTEM AND METHOD FOR NOTIFICATION PROVISION BASED ON AVAILABILITY

(71) Applicant: Intel Corporation, Santa Clara, CA (US)

(72) Inventors: Robert L. Vaughn, Albuquerque, NM (US); Charles Baron, Chandler, AZ (US)

(21) Appl. No.: 14/661,207

(22) Filed: Mar. 18, 2015

(51) Int. Cl. H04L 29/08; H04L 12/26

(52) U.S. Cl. CPC H04L 67/327; H04L 43/04

(57) ABSTRACT

Embodiments described herein relate generally to providing notifications over a network. A computing system may detect contextual information associated with a device. The contextual information may include, for example, information based on sensors of the device and/or information based on applications of the device. The computing system may determine whether the device is willing to receive a notification (e.g., a task or an alert) based on that contextual information. The computing system may indicate to a server whether the device is willing to receive the notification. If the device is willing to receive the notification, the server may communicate the notification to the device. Other embodiments may be described and/or claimed.

### FIELD OF INVENTION

Embodiments of the present invention relate generally to the technical field of data processing, and more particularly, to provision of notifications to devices based on contextual information associated with devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by their inclusion in this section.

Computing systems may be configured to communicate over a network, such as the Internet. Often, one computing system may wish to provide a notification to another computing system, such as in the case of an amber alert. Alternatively, one computing system may wish to provide a task to another computing system, such as a task to be performed by a user of the other computing system.

Frequently, information communicated over a network is performed without regard to how receptive a computing system may be to incoming information (e.g., tasks or alerts). For example, a task may be communicated to a computing system only in response to a request from that receiving computing system, or an alert may be communicated to a computing system irrespective of whether the user of that computing system wishes to receive such an alert. In order to increase acceptance rates by task workers for tasks, a system may increase a quantity of targeted task workers. However, such an increase may reduce the rate at which new tasks can be dispatched to task workers. Additionally, as task workers are presented with tasks when they are unable to accept and work on those tasks, the tasks may become a burden on both users and computing resources. Conversely, if a task worker is only willing to accept tasks when logged in and viewing a task-related application, then this may reduce the quantity of task workers that are available to service tasks. Therefore, a need exists to intelligently determine whether a computing system is more likely or willing to receive incoming information from a transmitting computing system.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they may mean at least one.

FIG. 1 is a block diagram illustrating an environment for providing notifications to devices based on contextual information associated with those devices, in accordance with various embodiments.

FIG. 2 is a block diagram illustrating a computing system, communicatively coupled with a device, that is to indicate if the device is to be provided a notification, in accordance with various embodiments.

FIG. 3 is a block diagram illustrating a computing system having a notification provision module to facilitate provision of notifications to devices, in accordance with various embodiments.

FIG. 4 is a flow diagram illustrating a method for facilitating provision of a task notification to a device, in accordance with various embodiments.

FIG. 5 is a flow diagram illustrating a method for providing a notification to a device based on application and sensor information associated with the device, in accordance with various embodiments.

FIG. 6 is a flow diagram illustrating a method for determining if a device is to be provided a notification based on contextual information associated with the device, in accordance with various embodiments.

FIG. 7 is a flow diagram illustrating a method for providing a notification to a device based on contextual information associated with the device, in accordance with various embodiments.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” and/or “logic” may refer to, be part of, or include an Application Specific Integrated Circuit (“ASIC”), an electronic circuit, a processor (shared, dedicated, or group), and/or memory (shared, dedicated, or group) that execute one or more software or firmware programs, a combinational logic circuit, and/or other suitable hardware components that provide the described functionality.

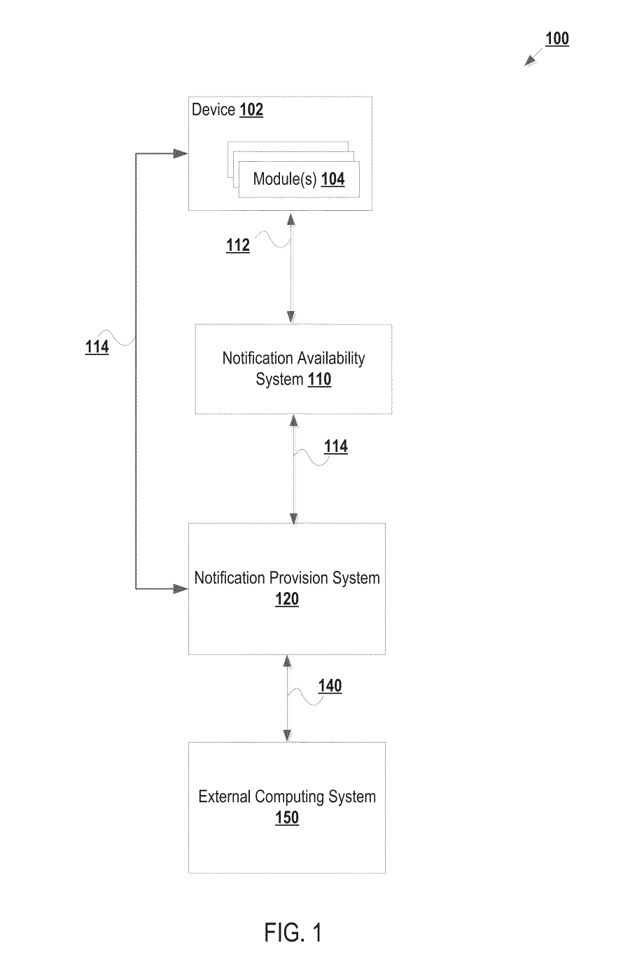

Beginning first with FIG. 1, a block diagram shows one embodiment of an environment 100 for providing notifications to devices based on contextual information associated with those devices, in accordance with various embodiments. The environment may include, but is not limited to, at least one device 102, a notification availability system 110, a notification provision system 120, and an external computing system 150.

Except for the teachings of the present disclosure, the device 102 may comprise, for example, a server, a desktop computer, a laptop computer, a portable electronic computer device, a smartphone, a personal data assistant, a tablet computer, an eBook reader, or essentially any other computer device adapted to transmit signals over a network. Examples of computing systems comprising the device 102 include servers available from Hewlett Packard of Palo Alto, Calif., desktop or laptop computers available from Dell Computer of Austin, Tex., smartphones and computing tablets available from Apple Computer of Cupertino, Calif., game consoles available from Nintendo Corporation of Tokyo, Japan, and so forth.

The device 102 may have stored therein a plurality of modules 104, which may include hardware, software, and/or firmware modules configured to detect various data indicative of a context of the device 102. In various embodiments, the modules may include sensors and/or applications. Examples of modules 104 include applications and/or sensors. In embodiments, an application may include voice and/or video communication applications (e.g., phone, videoconferencing, etc.), text messaging applications, social media applications, web browser applications, scheduling applications (e.g., calendar, to-do list, etc.), network connectivity applications, and so forth. A sensor may include a global navigation satellite system (“GNSS”) sensor (e.g., global positioning system), a thermometer, an ambient light sensor, a microphone, an inertial sensor, an accelerometer, and so forth. In one embodiment, at least one of the modules 104 may be an application configured to provide contextual information from the modules 104 to the notification availability system 110.

The device 102 may be communicatively coupled with the notification availability system over interconnect 112, which may be one or more buses or networks (e.g., a combination of wired and/or wireless networks including the Internet). In various embodiments, the notification availability system 110 may be integrated in the device 102, such as hardware, software, or firmware of the device 102.

In another embodiment, the notification availability system 110 may be separate from the device 102. For example, except for the teachings of the present disclosure, the notification availability system 110 may be a server and/or cloud computing system. In such embodiments, the notification availability system 110 may be configured to collect contextual information and provide notifications based thereon to a plurality of devices similar to the device 102 over a plurality of networks similar to the interconnect 112.

In embodiments, the notification availability system 110 may be configured to collect information associated with a context of the device 102, such as information provided by one or more modules 104. Based at least in part on the collected information, the notification availability system 110 may be configured to determine whether the device is to be provided a notification. In various embodiments, the notification availability system 110 may be configured to compute a value that is to indicate whether the device 102 is willing to receive a notification, such as a percentage value or a Boolean value. In another embodiment, the notification availability system 110 may be configured to provide, as the determination of whether the device is to be provided a notification, the collected contextual information as an indication of whether the device 102 is willing to receive the notification.

The notification availability system 110 may be communicatively coupled with a notification provision system 120 over one or more networks 114, which may be any combination of wired and/or wireless networks including the Internet. Except for the teachings of the present disclosure, the notification provision system 120 may comprise, for example, a server, a desktop computer, a laptop computer, a portable electronic computer device, a smartphone, a personal data assistant, a tablet computer, an eBook reader, or essentially any other computer device adapted to transmit signals over a network. Examples of computing systems comprising the notification provision system 120 include servers available from Hewlett Packard of Palo Alto, Calif., desktop or laptop computers available from Dell Computer of Austin, Tex., and/or smartphones and computing tablets available from Apple Computer of Cupertino, Calif.

The notification provision system 120 may be configured to identify a notification that is to be provided to the device 102. According to embodiments, a notification may comprise information that is to be presented to a user by the device 102, such as through visual presentation, audio presentation, and/or tactile presentation. For example, a notification may include an alert and/or a task. Examples of alerts include Amber alerts, weather alerts, traffic alerts, and so forth. A task may comprise a process having a definable completion point and requiring input from a user and/or consuming computing resources—for example, a task may be a project on which a user works for a relatively brief period of time (e.g., a duration of several seconds or a few minutes), such as receiving user input to answer a question, receiving user input to identify content of an image, consuming processor cycles to process data, and so forth.

In various embodiments, notification provision system 120 may not identify that the notification is to be provided specifically to the device 102, but rather may identify a notification that is to be provided to a group of devices that includes the device 102. In various embodiments, this notification may be provided to the notification provision system 120 over a network 140 (e.g., one or more wired and/or wireless networks, such as the Internet) from an external computing system 150 (e.g., a third-party server).

The notification provision system 120 may be configured to determine whether the device 102 is to be provided the notification based on the contextual information provided through the notification availability system 110. For example, the notification provision system 120 may be configured to evaluate a value (e.g., a Boolean value or a percentage value) that is to indicate whether the device 102 is willing to receive the notification. In another embodiment, the notification provision system 120 may determine whether the device 102 is to be provided the notification by computing a value (e.g., a Boolean value or a percentage value) for the device 102 based on contextual information associated with the device 102. The notification provision system 120 may perform a plurality of determinations for a plurality of devices (including the device 102) to determine if a respective device is to be provided the notification.

Based on the determination, the notification provision system 120 may be configured to transmit the notification to the device 102, for example, over one or both of the interconnect 112 and/or the network 114. In an embodiment, the notification provision system 120 and/or the external computing system 150 may be configured to provide the notification to the device 102 without communication through the notification availability system 110. For example, the notification provision system 120 may be configured to communicate with the device 102 over network 114, which may be the Internet.

In embodiments in which the notification is a task, the notification provision system 120 may be configured to receive an indication of a result associated with the task (e.g., from the device 102 and/or through the notification availability system 110). In an embodiment, the device 102 may be configured to provide the result to the notification provision system 120 and/or the external computing system 150 without communication through the notification availability system 110. For example, the device 102 may be configured to provide the result to the notification provision system 120 and/or the external computing system 150 over network 114, which may be the Internet.

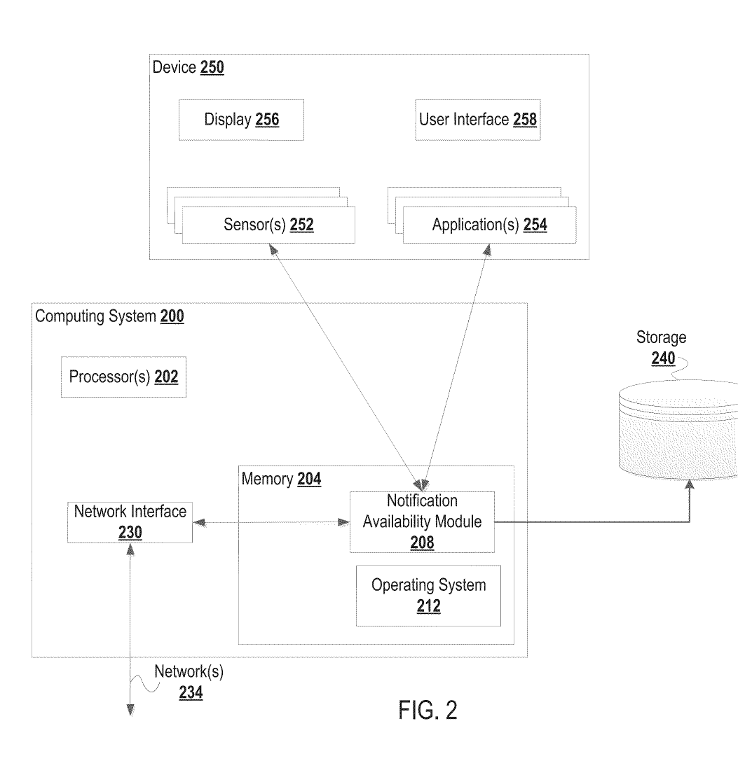

With reference now to FIG. 2, a block diagram is shown illustrating a computing system 200, communicatively coupled with a device 250, that is to indicate if the device 250 is to be provided a notification, in accordance with various embodiments. The computing system 200 may be an embodiment of the notification availability system 110, the device 250 may be an embodiment of the device 102, and/or the sensor(s) 252 and/or application(s) 254 may be embodiments of the module(s) 104 illustrated in FIG. 1.

In various embodiments, the device 250 may be communicatively coupled with the computing system 200 over one or more wired and/or wireless networks, such as the Internet. For example, the computing system 200 may be a cloud computing server.

In another embodiment, the device 250 may be electrically coupled with the computing system 200, such as via one or more computer buses or other electrical-connection means. In such embodiments, the device 250 and the computing system 200 may share one or more components, including processor(s) 202, network interface 230, memory 204, and/or a housing (not shown). Further to such embodiments, the notification availability module 208 may be implemented as software, hardware, firmware, or a combination thereof in the device 250 and computing system 200.

Similarly, the storage 240 may be communicatively coupled with the device 250 and/or the computing system 200. The storage 240 is intended to represent any storage media suitable to store data. Examples of the storage 240 include flash (e.g., NAND flash), electrically erasable programmable read-only memory (EEPROM), hard disk drive (HDD), and so forth. In some embodiments, the storage 240 may comprise a database. In one embodiment, the storage 240 may be accessible over one or more wired and/or wireless networks (e.g., the Internet), such as where the storage 240 is provided as cloud storage. In another embodiment, the storage 240 may be electrically coupled (e.g., via one or more computer buses) to components 204, 202, 230 of the computing system 200 and/or components 252, 254, 256, 258 of the device 250. Accordingly, the storage 240 may be included in a housing (not shown) of the device 250 and/or the computing system 200.

As illustrated, the device 250 may include, but is not limited to, one or more sensor(s) 252, one or more application(s) 254, a display 256, and a user interface 258. Instructions associated with one or more of the components 252, 254, 256, 258 of the device 250 may be executed by one or more processor(s), such as the processor(s) 202 of the computing system 200, and may be configured for execution by an operating system (e.g., the operating system 212). The display 256 is intended to represent a broad range of display elements known in the art. Likewise, user interface 258 is intended to represent a broad range of components suitable to allow interaction by a user with the device 250—e.g., the user interface 258 may be presented to a user on the display 256 as a graphical user interface or through a command line interface. To receive user input, the user interface 258 may be implemented in hardware, software, or a combination of the two and may include and/or may be communicatively coupled with one or more hardware components suitable for user input (e.g., a keyboard, mouse, touch screen, gesture recognition, microphone, etc.).

In various embodiments, the application(s) 254 may include one or more of voice and/or video communication applications (e.g., phone, videoconferencing, etc.), text messaging applications, social media applications, web browser applications, scheduling applications (e.g., calendar, to-do list, etc.), network connectivity applications, and the like. In various embodiments, the sensor(s) 252 may include one or more of a GNSS sensor (e.g., global positioning system), a thermometer, an ambient light sensor, a microphone, an inertial sensor, an accelerometer, and the like.

As shown, the computing system 200 may include, but is not limited to, one or more processor(s) 202, memory 204, and a network interface 230. The processor(s) 202 is intended to represent a broad range of processor arrangements including, but not limited to, arrangements with single or multi-core processors of various execution speeds and power consumptions, as well as processors of various types (e.g., a graphics processing unit, a microprocessor, etc.). Similarly, the memory 204 is intended to represent a broad range of memory arrangements of various architectures with one or more levels of caches, and of various types, such as dynamic random access, FLASH, and so forth.

The network interface 230 may be comprised of transmit circuitry and/or receive circuitry. The network interface 230 may be configured to transmit and/or receive data over any number of different wired and/or wireless networks. Accordingly, the one or more network(s) 234 is (are) intended to represent a broad range of networks known in the art. Examples of network(s) 234 may include wired or wireless, local or wide area, private or public networks, including the Internet.

In various embodiments, an operating system 212 may be loaded into memory 204 and executed by the processor(s) 202 of the computing system 200. The operating system 212 may be configured to initiate the execution of the instructions, such as instructions provided by the notification availability module 208. In particular, the operating system 212 may be adapted to serve as a platform for running the notification availability module 208. The operating system 212 may be adapted to perform other operations across the components of the computing system 200, including threading, resource management, data storage control, and other similar functionalities.

The operating system 212 may cause the processor(s) to execute instructions for the notification availability module 208. The notification availability module 208 may include code representing instructions configured to collect information from one or more of the sensor(s) 252 and/or application(s) 254. In various embodiments, the notification availability module 208 may be configured to store collected information in the storage 240. This information may be indicative of a context associated with the device 250.

In an embodiment in which the computing system 200 comprises the device 250, the notification availability module 208 may comprise one of the application(s) 254. In another embodiment in which the computing system 200 may connect with the device 250 over the network(s) 234, the computing system 200 may be configured to receive information from the sensor(s) 252 and/or application(s) 254 through the network interface 230.

Based on the information stored in the storage 240, the notification availability module 208 may be configured to determine whether the device 250 is to be provided a notification. In one embodiment, the notification availability module 208 may compute a value that is to indicate whether the device 250 is to be provided a notification. This value may be, for example, a Boolean value (e.g., “yes,” provide a notification or “no,” do not provide a notification) or a percentage value indicating how willing the device 250 may be to reception of a notification.

In another embodiment, the notification availability module 208 may be configured to determine whether the device 250 is to be provided a notification based on selection or identification of stored information indicative of a context of the device 250 that is to be provided to a remote computing system (e.g., a notification provision system). For example, the notification availability module 208 may select data from one or more sensor(s) 252 and/or application(s) 254 that indicate the context of the device 250 so that a remote computing system may facilitate a determination of whether the device 250 is to be provided a notification.

Further, the notification availability module 208 may be configured to analyze stored data associated with the device 250 to determine whether the device 250 is to be provided a notification. In various embodiments, the notification availability module 208 may estimate or predict whether the device 250 is to be provided a notification based on an analysis of previously collected information, such as different sets of information indicative of different contexts of the device 250.

For example, the notification availability module 208 may be configured to store inputs received through the user interface 258 that indicate whether the device 250 is to be provided a notification and associate a respective context of the device 250 with a respective input. Accordingly, when the device 250 is determined to be in a later context based on information collected from the sensor(s) 252 and/or application(s) 254, the notification availability module 208 may determine whether the device is to be provided a notification based on an input from the similar previous context. Thus, in embodiments, the notification availability module 208 may dynamically determine whether a notification is to be provided to the device 250 without an explicit input through the user interface 258 indicative of a request for a notification.

According to one embodiment, the notification availability module 208 may be configured to allow exceptions to determinations of whether the device 250 is to be provided a notification. The notification availability module 208 may be configured to determine that the device 250 is not to be provided notifications in certain contexts (e.g., where a GNSS sensor 252 indicates the device 250 is traveling at a driving speed, where a telephone application indicates that device 250 is engaged in a voice call, etc.), but may be configured to allow notifications, such as relevant and/or emergency notifications. For example, the notification availability module 208 may be configured to determine that the device 250 is not to be provided a task when the device is located at an athletic venue (e.g., baseball stadium), but may be configured for an exception that is to allow tasks that are relevant to a particular athletic event (e.g., baseball). Thus, the notification availability module 208 may be configured to compute a relevancy value that indicates if an exception allows provision of one or more notifications.

Based on the determination, the notification availability module 208 may be configured to cause the network interface 230 to transmit an indication to another computing system (not shown) over the network(s) 234. This indication may be anonymized so as to protect an identity associated with the device 250 and/or the computing system 200. For example, an Amber Alert may be identified by another computing system as a notification to be provided to devices in a particular geographic location and the notification availability module 208 may be configured to provide an anonymized indication of device location with (e.g., as part of) or separately from the indication of the determination.

In one embodiment, the notification availability module 208 may perform one or more operations described herein in response to a request to provide a notification to the device 250. For example, the notification availability module 208 may collect information associated with a context of the device 250 and/or determine whether the device is to be provided the notification in response to a request to provide a notification.

Based on transmission of the indication of the determination, the notification availability module 208 may be configured to receive a notification from another computing system (e.g., a notification provision system) through the network interface 230. In various embodiments, the notification availability module 208 may be configured to present the notification on the device 250, for example, through the display 256 and/or through a sensor(s) 252 (e.g., a speaker).

In embodiments, the notification availability module 208 may be configured to receive input from the user interface 258 associated with the notification. For example, the notification availability module 208 may cause a task to be presented to the user on the display 256 and, through the user interface 258, the notification availability module 208 may receive input associated with the task. In one embodiment, the notification availability module 208 may be configured to transmit an indication of a result associated with the task to the other computing system through the user interface 258. In another embodiment, the notification availability module 208 may be configured to transmit an indication of a completion status as the result associated with the task (e.g., “completed,” “in progress,” etc.).

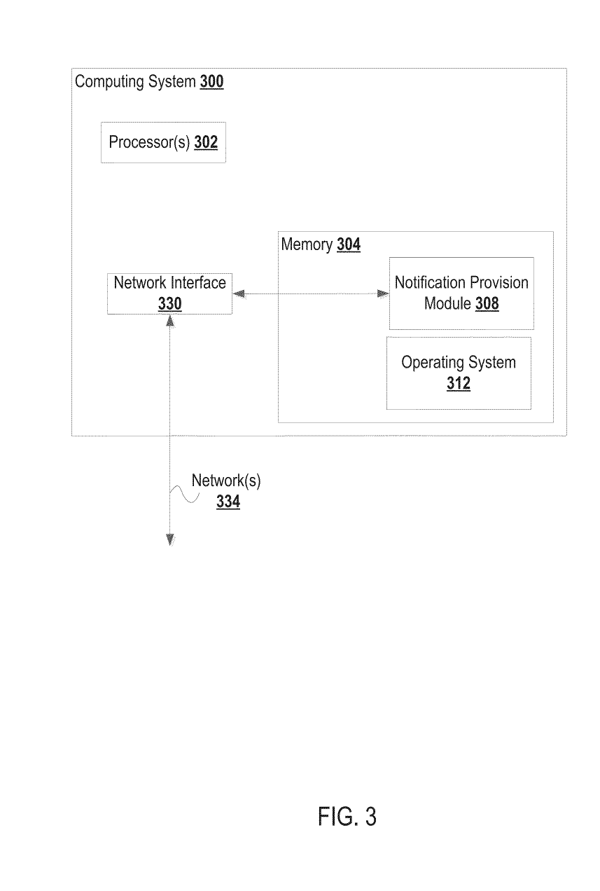

Turning to FIG. 3, a block diagram is shown illustrating a computing system 300 having a notification provision module 308 to facilitate provision of notifications to devices, in accordance with various embodiments. The computing system 300 may be an embodiment of the notification provision system 120 illustrated in FIG. 1.

As shown, the computing system 300 may include, but is not limited to, one or more processor(s) 302, memory 304, and a network interface 330. The processor(s) 302 and memory 304 may be configured to execute at least an operating system 312 and a notification provision module 308.

The processor(s) 302 is (are) intended to represent a broad range of processors including, but not limited to, arrangements with single or multi-core processors of various execution speeds and power consumptions. Similarly, the memory 304 is intended to represent a broad range of memory arrangements including, but not limited to, memory arrangements of various architectures with one or more levels of caches, and of various types, such as dynamic random access, FLASH, and so forth. In various embodiments, the memory 304 may include and/or may be communicatively coupled with non-volatile memory, such as include read-only memory, flash memory, ferroelectric RAM (F-RAM), various types of magnetic computer storage devices (e.g., hard disks, floppy disks, and magnetic tape), optical discs, and other storage elements known in the art.

The network interface 330 may be comprised of transmit circuitry and/or receive circuitry. The network interface 330 may be configured to transmit and/or receive data over any number of different wired and/or wireless networks. Accordingly, the one or more network(s) 334 is (are) intended to represent a broad range of networks known in the art. Examples of network(s) 334 may include wired or wireless, local or wide area, private or public networks, including the Internet.

In various embodiments, the operating system 312 may be configured to initiate the execution of the instructions, such as instructions provided by the notification provision module 308. In particular, the operating system 312 may be a platform for running the notification provision module 308. The operating system 312 may be adapted to perform other operations across the components of the computing system 300, including threading, resource management, data storage control, and other similar functionalities.

The operating system 312 may cause the processor(s) 302 and memory 304 to execute instructions for the notification provision module 308. The notification provision module 308 may include code representing instructions configured to provide one or more devices (not shown) based on information associated with respective contexts of those devices.

In various embodiments, the notification provision module 308 may receive one or more notifications to be provided to one or more devices from another computing system (e.g., a third party computing system). In connection with the one or more notifications, the notification provision module 308 may also receive an indication of devices to which the one or more notifications are to be provided. For example, the notification provision module 308 may receive an Amber Alert and, in connection, therewith, receive an indication of a geographic location wherein devices within the geographic location are to be provided the Amber Alert. In another example, the notification provision module 308 may receive a task, and in connection therewith, receive an indication of a context, wherein devices associated with similar contexts are to be provided the task.

The notification provision module 308 may identify one or more notifications to be provided to one or more devices. In various embodiments, the notification provision module 308 may be configured to distribute notifications to all devices configured to receive such notifications. For example, the computing system 300 may have stored therein a list of devices that are to receive tasks and the notification provision module 308 may identify a task (e.g., a received task) that is to be distributed to listed devices. In one embodiment, the notification provision module 308 may be configured to transmit a request to provide a notification to a device.

Through the network interface 330, the notification provision module 308 may receive information associated with a context of a device to which the notification may be provided. Based on the information associated with the context of the device, the notification provision module 308 may determine whether the device is to be provided the notification. In various embodiments, the information associated with the context of the device may be a value, such as a Boolean value or percentage value, and the notification provision module 308 may evaluate the value to determine whether the device is to be provided the notification—e.g., the notification provision module 308 may compare the value to a threshold value.

In another embodiment, the information associated with the context of the device may be information from one or more sensors and/or applications of the device. The notification provision module 308 may be configured to evaluate this information to determine if the notification is to be provided to the device. For example, the notification provision module 308 may evaluate the information to determine that the notification is or is not relevant to the context of the device or is not safe to be provided to the device in the device's current context (e.g., notifications may not be provided to the device where the information indicates the device's context is in a car wherein the user is the driver).

Where the notification provision module 308 determines that the device is not to be provided the notification, the notification provision module 308 may queue the notification for delivery at a later time. Thereafter, the notification provision module 308 may receive new information associated with a new context of the device and may determine that the notification is to be provided to the device. Alternatively, the notification provision module 308 may discard the notification, such as where the notification comprises a time-sensitive task. Where the notification provision module 308 determines that the device is to be provided the notification, the notification provision module 308 may cause the network interface 330 to transmit the notification to the device.

According to various embodiments, the notification provision module 308 may receive a response to the notification from the device. For example, the notification provision module 308 may receive a result of a task, such as an indication of a completion status and/or user input associated with performance of the task at the device. In one embodiment, the notification provision module 308 may be configured to transmit the result to another computing system (e.g., a computing system that provided the notification).

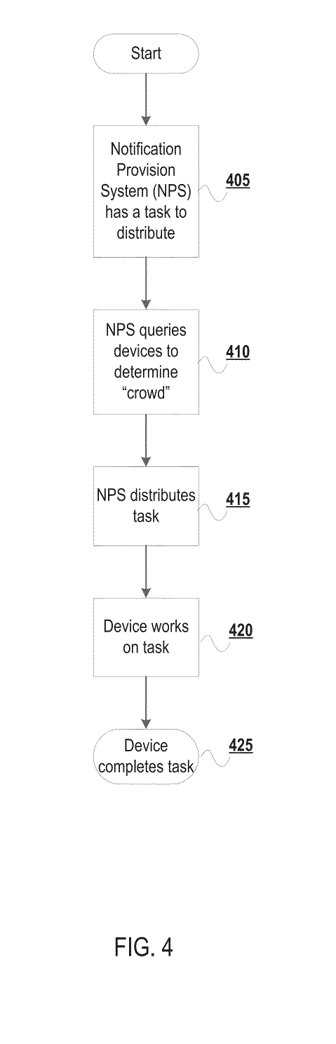

Now with reference to FIG. 4, a flow diagram illustrates a method 400 for facilitating provision of a task notification to a device, in accordance with various embodiments. The method 400 may be performed by a device and notification availability system communicatively coupled with a notification provision system, such as the device 102 and notification availability system 110 communicatively coupled with the notification provision system 120 of FIG. 1. While FIG. 4 illustrates a plurality of sequential operations, one of ordinary skill would understand that one or more operations of the method 400 may be transposed and/or performed contemporaneously.

At operation 405, a notification provision system may identify a task to distribute. The notification provision system may identify a task that is relevant to a specific context or relevant to all devices configured to receive tasks.

Thereafter, the notification provision system may query one or more devices to determine “crowd” size, as illustrated at operation 410. For example, the notification provision system may query to determine which devices are capable of receiving a task—e.g., the notification provision system may query to determine which devices are within a geographic location relevant to the task, the notification provision system may query to determine which devices are associated with users within a specific demographic, etc.

In connection with this query at operation 410, the notification provision system may determine which devices of the “crowd” are to be provided the notification. For example, a first device may provide an indication that this first device is not to be provided a task in its current context, whereas a second device may provide an indication that it is to be provided a task in its current context. At operation 415, the notification provision system distributes the task to those queried devices that are capable and willing to be provided the task.

Accordingly, at operation 420, the one or more devices to which the task is distributed work on the task—e.g., a device may receive user input in connection with the task. At operation 425, one or more devices may complete the distributed task and may transmit respective results to the notification provision system.

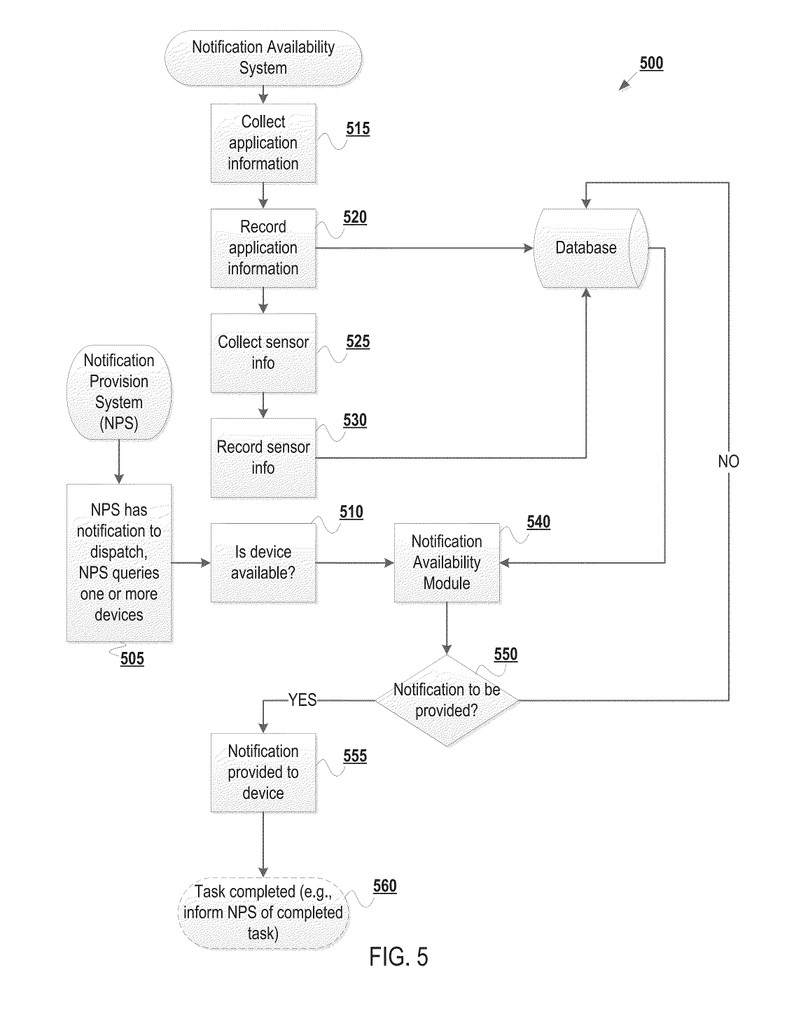

Now with reference to FIG. 5, a flow diagram illustrates a method 500 for providing a notification to a device based on application and sensor information associated with the device, in accordance with various embodiments. The method 500 may be performed by a device and notification availability system communicatively coupled with a notification provision system, such as the device 102 and notification availability system 110 communicatively coupled with the notification provision system 120 of FIG. 1. While FIG. 5 illustrates a plurality of sequential operations, one of ordinary skill would understand that one or more operations of the method 500 may be transposed and/or performed contemporaneously.

At operation 505, a notification provision system may identify a notification that is to be provided to one or more devices. Accordingly, the notification provision system may query one or more devices to determine if the one or more devices are available to receive the notification.

At operation 510, the notification provision system may determine if a respective device is available to receive the notification. In various embodiments, this operation 510 may include indicating to the notification availability system that the notification provision system would like to provide a notification to the respective device. In connection with this query, the notification availability module may begin to perform an operation 540 to determine if the respective device is to receive the notification.

At operation 515, the notification availability system may collect application information associated with one or more applications of the respective device. This collected application information may be recorded in database storage, as illustrated at operation 520. Similarly, at operation 525, the notification availability system may collect sensor information associated with the respective device. This collected sensor information may be recorded in database storage, as illustrated at operation 530.

Table 1 illustrates an example of information that may be collected from applications and/or sensors of a device and stored by the notification availability module.

TABLE 1

| ID | Data | Information | Meaning | Dependancy Group |
|---|---|---|---|---|
| 1000 | Sensor: GPS | GPS speed | Is the user in motion? | 1000, 1001, 1002, 1003 |
| 1001 | Sensor: GPS | GPS route type | Is the user in a car, train or other? | 1000, 1001, 1002, 1003 |
| 1002 | Antenna: WIFI, LTE, etc. | Nearby users (wireless devices) | Is the user with other people? | 1000, 1001, 1002, 1003 |
| 1003 | Antenna: WIFI, LTE, etc. | Relative positioning of user in crowd | Is the user in the driver seat if in a | 1000, 1001, 1002, 1003 |
| | | based on EM and acoustic signal strength | car? | |
| | | analysis and/or location orientation | | |
| 1004 | App: Phone | Active phone call | Is the user in an active phone call? | 1004 |
| 1005 | App: Schedule | Active meeting or meeting starting soon | Does the user have a meeting to | 1005 |
| | | | attend or is already in? | |
| 1006 | Sensor: Temperature | Ambient temperature | “normal” then it may be assumed | 1000, 1006 |
| | | | that the user is occupied in an | |
| | | | outdoor activity | |
| 1007 | App: Text | Is the user actively texting or has a recent | Is the user occupied with texing? | 1007 |
| | | text been received? | | |
| 1008 | Sensor: GPS | Location | What room is the user in? Are there | 1008, 1003 |
| | | | specific locations that the user is | |
| | | | more accepting of tasks than other | |
| | | | rooms? This entry may be described | |
| | | | as the “bathroom” identifier. | |

In continuing operation 540, the notification availability module may determine if the respective device is to be provided the notification based on the recorded information stored in the database. Where the notification availability module determines that the device is not to be provided the notification, at operation 550 the notification availability module may store in the database an indication of the context (e.g., the collected sensor and/or application information) in which the device is not to be provided the notification. Accordingly, the notification availability module may be able to reduce durations for determinations in the future when the device is in similar or the same contexts by accessing historical trends.

Where the notification availability module determines that the device is to be provided the notification, the notification availability module may so indicate to the notification provision system and, at operation 555, the notification provision system may provide the notification to the device. In various embodiments, the notification may comprise a task. Accordingly, at optional operation 560, the task may be completed at the device and the notification provision system may be provided a result thereof.

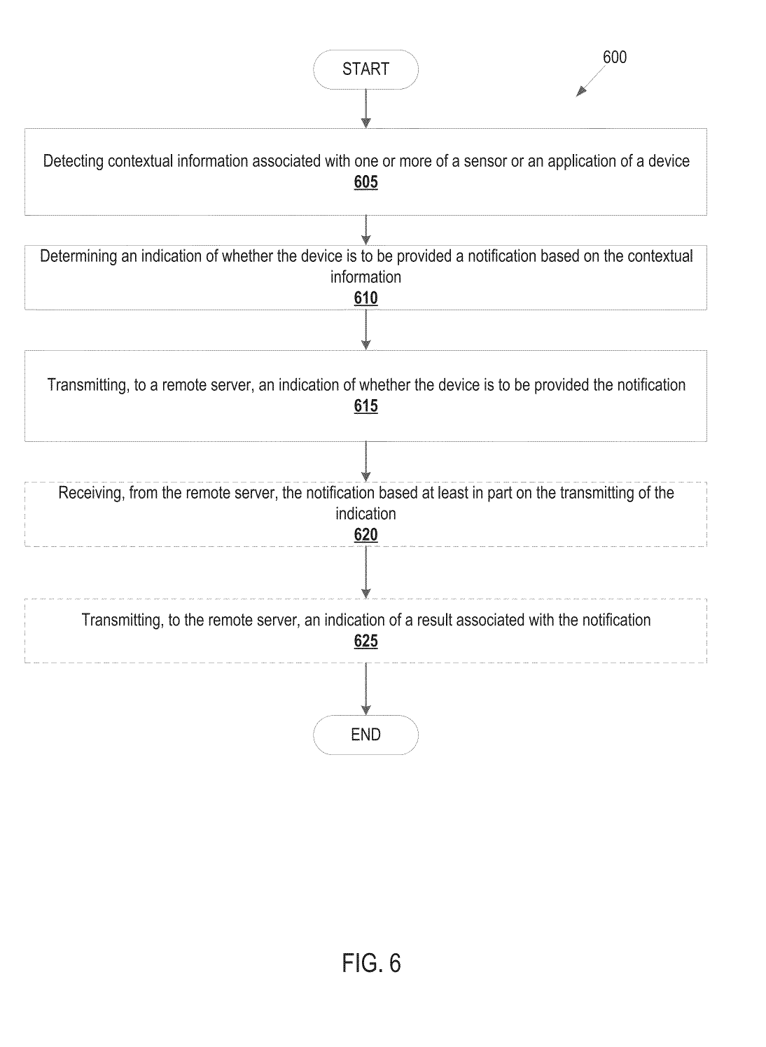

With respect to FIG. 6, a flow diagram illustrates a method 600 for determining if a device is to be provided a notification based on contextual information associated with the device, in accordance with various embodiments. The method 600 may be performed by a notification availability system, such as the notification availability system 110 of FIG. 1. While FIG. 6 illustrates a plurality of sequential operations, one of ordinary skill would understand that one or more operations of the method 600 may be transposed and/or performed contemporaneously.

Beginning first with operation 605, the method 600 may include detecting contextual information associated with one or more of a sensor or an application of a device. Operation 610 may comprise determining an indication of whether the device is to be provided a notification based on the contextual information. In various embodiments, operation 610 may comprise operations associated with computing a value (e.g., a Boolean value, a percentage value, an integer, etc.) that is to indicate whether the device is willing to receive a notification. In another embodiment, operation 610 may comprise determining a portion or all of the contextual information that is indicative of whether the device is willing to receive a notification.

At operation 615, the method 600 may comprise transmitting an indication of whether the device is to be provided the notification. This indication may be transmitted to a remote server, such as a notification provision system. Where the indication specifies that the device is not to be provided a notification, the method 600 may end.

Conversely, the method 600 may advance to operation 620 where the indication specifies that the device is to be provided a notification. Operation 620 may comprise receiving, from the remote server, the notification based at least in part on the transmitting of the indication. In various embodiments, this notification may comprise, for example, a task or an alert. Where the notification comprises a task, the task may be performed at the device. Subsequently, operation 625 may comprise transmitting, to the remote server, an indication of a result associated with the notification (e.g., a task result).

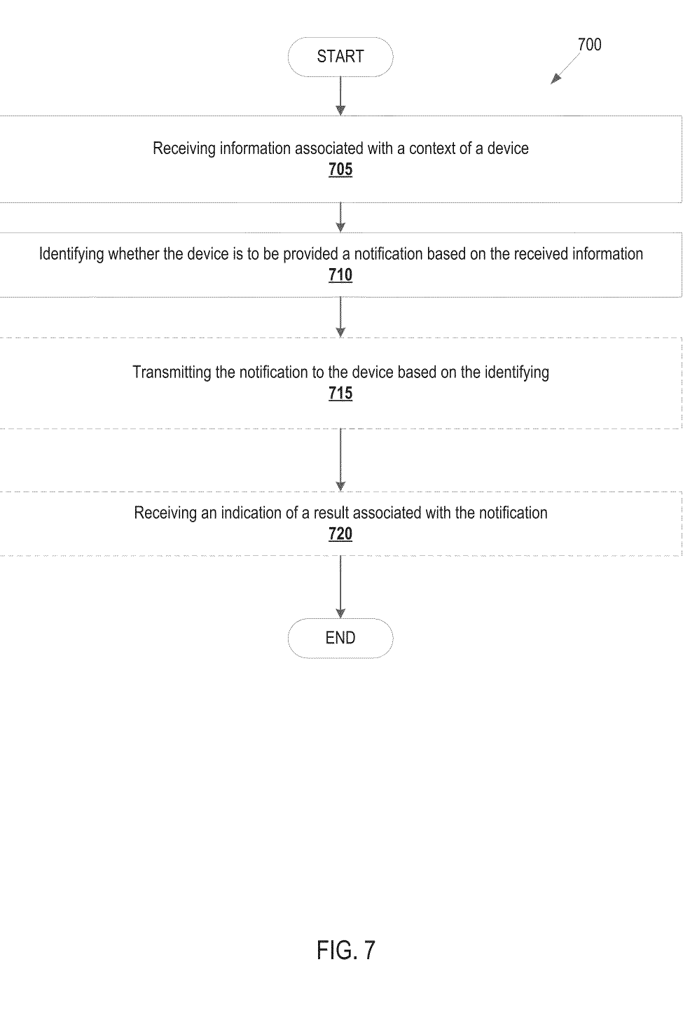

Turning to FIG. 7, a flow diagram illustrates a method 700 for providing a notification to a device based on contextual information associated with the device, in accordance with various embodiments. The method 700 may be performed by a notification provision system, such as the notification provision system 120 of FIG. 1. While FIG. 7 illustrates a plurality of sequential operations, one of ordinary skill would understand that one or more operations of the method 700 may be transposed and/or performed contemporaneously.

Beginning first with operation 705, the method 700 may comprise receiving information associated with a context of a device. In various embodiments, this information may be a value indicative that the device is not willing to receive notifications in its current context. For example, the information may comprise a Boolean value, a percentage value, a numerical value, and so forth. In another embodiment, this information may comprise information from one or more sensors and/or applications of the device.

At operation 710, the method 700 may comprise identifying whether the device is to be provided a notification based on the received information. In one embodiment, operation 710 may comprise operations associated with evaluating a value, such as evaluating a Boolean value or comparing a percentage to a threshold. In another embodiment, operation 710 may comprise operations associated with computing a determination of whether the device is to be provided a notification based on information from one or more sensors and/or applications of the device. Where the identifying of operation 710 indicates that the device is not to be provided a notification, the method 700 may end. Conversely, the method 700 may proceed to operation 715 where operation 710 indicates that the device is to be provided a notification.

At operation 715, the method 700 may include transmitting the notification to the device based on the identifying. In various embodiments, this notification may be a task or an alert. Where the notification is a task, the task may be performed at the device and the device may transmit a result of the task. Therefore, operation 720 may comprise receiving an indication of a result associated with the notification.

In various embodiments, example 1 may be a computing system for dynamic notification provision, the computing system comprising: one or more first processors; physical memory, coupled with the one or more processors; a network interface to transmit data to a remote server; and a notification availability module, to be loaded into the physical memory and operated by the one or more processors and coupled with the network interface, to: collect information associated with a context of a device; determine whether the device is to be provided a notification, based at least in part on the information collected; and cause the network interface to transmit an indication of the determination to the remote server. Example 2 may include the computing system of example 1, wherein the computing system comprises the device. Example 3 may include the computing system of example 1, wherein the computing system is a cloud server, and wherein the notification availability module, as part of collection of information, is to: receive, through the network interface and from the device, the information associated with the context. Example 4 may include the computing system of example 1, wherein the notification availability module is further to: process a notification, received through the network interface and from the remote server based on the transmission of the indication of the determination to the remote server. Example 5 may include the computing system of example 4, wherein the notification is to indicate one of an alert or a task to be performed. Example 6 may include the computing system of example 5, wherein the notification availability module is further to determine a result associated with the task and is to cause the network interface to transmit the result to the remote server. Example 7 may include the computing system of any of examples 1-6, wherein the notification availability module is to collect the information associated with the context based on data provided by one or more sensors of the device. Example 8 may include the computing system of example 7, wherein the one or more sensors include one or more of a satellite-based navigation system, a thermometer, an ambient light sensor, a microphone, an inertial sensor, and an accelerometer. Example 9 may include the computing system of any of examples 1-6, wherein the notification availability module is to collect the information associated with the context based on data provided by one or more applications of the device. Example 10 may include the computing system of example 9, wherein the one or more applications include one or more of a network connectivity application, a voice communication application, a text communication application, a browser, and a calendar application. Example 11 may include the computing system of any of examples 1-6, wherein the notification availability module is to determine whether the device is to be provided a notification based on computation of value, the value comprising one of a Boolean value or a percentage value.

Example 12 may be a computing system for provision of notifications to a device, the computing system comprising: one or more processors; physical memory, coupled with the one or more processors; a network interface to transmit data to and receive data from a device; and a notification provision module, to be loaded into the physical memory and operated by the one or more processors and coupled with the network interface, to: identify a notification to be provided to the device; receive, through the network interface, information associated with a context of the device; determine whether the device is to be provided the notification based on the information associated with the context; and cause the network interface to transmit the notification to the device based on the determination. Example 13 may include the computing system of example 12, wherein the network interface is to transmit data to and receive data from the device through a cloud computing system. Example 14 may include the computing system of example 12, wherein the notification provision module is to identify the notification based on information received through the network interface from a remote server. Example 15 may include the computing system of example 12, wherein the notification is to indicate one of an alert or a task to be performed. Example 16 may include the computing system of example 15, wherein the notification provision module is further to process a result associated with the task and received through the network interface from the device. Example 17 may include the computing system of any of examples 12-16, wherein the information received by the notification provision module comprises a Boolean value, and the notification provision module is to determine whether the device is to be provided the notification based on the Boolean value. Example 18 may include the computing system of any of examples 12-16, wherein the information received by the notification provision module comprises a percentage value, and the notification provision module is to determine whether the device is to be provided the notification based the percentage value. Example 19 may include the computing system of any of examples 12-16, wherein the information received by the notification provision module comprises information associated with at least one of a sensor of the device or an application of the device, and the notification provision module is to determine whether the device is to be provided the notification based the information associated with the at least one of the sensor or the application.

Example 20 may be one or more non-transitory computer-readable media comprising executable instructions, wherein the instructions, in response to execution by a computer system, cause the computer system to: detect contextual information associated with one or more of a sensor or an application of a device; determine an indication of whether the device is to be provided a notification based on the contextual information; and transmit, to a remote server, the indication of whether the device is to be provided the notification. Example 21 may include the one or more non-transitory computer-readable media of example 20, wherein to determine comprises to determine whether the device is to be provided with a notification that indicates one of an alert or a task associated with the device. Example 22 may include the one or more non-transitory computer-readable media of any of examples 20-21, wherein to transmit comprises to transmit an indication that comprises one of a value or the contextual information.

Example 23 may be a computer-implemented method comprising: receiving, by a computer, information associated with a context of a device; identifying, by the computer, whether the device is to be provided a notification based on the information; and transmitting, by the computer, the notification to the device based on the identifying. Example 24 may include the method of example 23, wherein identifying comprises identifying a notification to indicate one of an alert or a task associated with the device. Example 25 may include the method of any of examples 23-24, wherein receiving comprises receiving information having one of a value or information associated with a context of the device.

Example 26 may be a computer-implemented method comprising: collecting, by a computing system, information associated with a context of a device; determining whether the device is to be provided a notification, based at least in part on the information collected; and transmitting an indication of the determination to a remote server. Example 27 may include the method of example 26, wherein the computing system comprises the device. Example 28 may include the method of example 26, wherein the computing system is a cloud server, and wherein the method further comprises: receiving, from the device, the information associated with the context. Example 29 may include the method of example 26, further comprising: receiving, from the remote server, a notification based on the transmitting of the indication of the determination to the remote server. Example 30 may include the method of example 26, wherein the notification is to indicate one of an alert or a task to be performed.

Example 31 may be an apparatus comprising: means for collecting, by a computing system, information associated with a context of a device; means for determining whether the device is to be provided a notification, based at least in part on the information collected; and means for transmitting an indication of the determination to a remote server. Example 32 may include the apparatus of example 31, wherein the computing system comprises the device. Example 33 may include the apparatus of example 31, wherein the computing system is a cloud server, and wherein the apparatus further comprises: means for receiving, from the device, the information associated with the context. Example 34 may include the apparatus of example 31, further comprising: means for receiving, from the remote server, a notification based on the transmitting of the indication of the determination to the remote server. Example 35 may include the apparatus of example 31, wherein the notification is to indicate one of an alert or a task to be performed.

Example 36 may be an apparatus comprising: means for identifying a notification to be provided to a device; means for receiving information associated with a context of the device;

means for determining whether the device is to be provided the notification based on the information associated with the context; and means for transmitting the notification to the device based on the determination. Example 37 may include the apparatus of example 36, wherein the means for receiving the information comprises means for receiving the information through a cloud computing system. Example 38 may include the apparatus of example 36, wherein the means for identifying comprises means for identifying the notification based on information received from a remote server. Example 39 may include the apparatus of example 36, wherein the notification is to indicate one of an alert or a task to be performed. Example 40 may include the apparatus of example 39, further comprising: means for processing a result associated with the task and received from the device.

Embodiments of the invention also relate to an apparatus for performing the operations herein. Such a computer program is stored in a non-transitory computer-readable medium. A machine-readable medium includes any mechanism for storing information in a form readable by a machine (e.g., a computer). For example, a machine-readable (e.g., computer-readable) medium includes a machine- (e.g., a computer-) readable storage medium (e.g., read only memory (“ROM”), random access memory (“RAM”), magnetic disk storage media, optical storage media, flash memory devices). Embodiments described herein may also include storage that is in a cloud (e.g., remote storage accessible over a network), which may be associated with the Internet of Things (“IoT”). In such embodiments, data may be distributed across multiple machines (e.g., computing systems and/or IoT devices), including a local machine.

The processes or methods depicted in the preceding figures can be performed by processing logic that comprises hardware (e.g., circuitry, dedicated logic, etc.), software (e.g., embodied on a non-transitory computer-readable medium), or a combination of both. Although the processes or methods are described above in terms of some sequential operations, it should be appreciated that some of the operations described can be performed in a different order. Moreover, some operations can be performed in parallel rather than sequentially.

Embodiments of the present invention are not described with reference to any particular programming language. It will be appreciated that a variety of programming languages can be used to implement the teachings of embodiments of the invention as described herein.

In the foregoing Specification, embodiments of the invention have been described with reference to specific exemplary embodiments thereof. It will be evident that various modifications can be made thereto without departing from the broader spirit and scope of the invention as set forth in the following claims. The Specification and drawings are, accordingly, to be regarded in an illustrative sense rather than a restrictive sense.

What is claimed is:

1. A computing system for dynamic notification provision, the computing system comprising:
one or more first processors;
physical memory, coupled with the one or more processors;
a network interface to transmit data to a remote server; and
a notification availability module, to be loaded into the physical memory and operated by the one or more processors and coupled with the network interface, to:
collect information associated with a context of a device;
determine whether the device is to be provided a notification, based at least in part on the information collected; and
cause the network interface to transmit an indication of the determination to the remote server.

2. The computing system of claim 1, wherein the computing system comprises the device.

3. The computing system of claim 1, wherein the computing system is a cloud server, and wherein the notification availability module, as part of collection of information, is to:
receive, through the network interface and from the device, the information associated with the context.

4. The computing system of claim 1, wherein the notification availability module is further to:
process a notification, received through the network interface and from the remote server based on the transmission of the indication of the determination to the remote server.

5. The computing system of claim 4, wherein the notification is to indicate one of an alert or a task to be performed.

6. The computing system of claim 5, wherein the notification availability module is further to determine a result associated with the task and is to cause the network interface to transmit the result to the remote server.

7. The computing system of claim 1, wherein the notification availability module is to collect the information associated with the context based on data provided by one or more sensors of the device.

8. The computing system of claim 7, wherein the one or more sensors include one or more of a satellite-based navigation system, a thermometer, an ambient light sensor, a microphone, an inertial sensor, and an accelerometer.

9. The computing system of claim 1, wherein the notification availability module is to collect the information associated with the context based on data provided by one or more applications of the device.

10. The computing system of claim 9, wherein the one or more applications include one or more of a network connectivity application, a voice communication application, a text communication application, a browser, and a calendar application.

11. The computing system of claim 1, wherein the notification availability module is to determine whether the device is to be provided a notification based on computation of value, the value comprising one of a Boolean value or a percentage value.

12. A computing system for provision of notifications to a device, the computing system comprising:
one or more processors;
physical memory, coupled with the one or more processors;
a network interface to transmit data to and receive data from a device; and
a notification provision module, to be loaded into the physical memory and operated by the one or more processors and coupled with the network interface, to:
identify a notification to be provided to the device;
receive, through the network interface, information associated with a context of the device;
determine whether the device is to be provided the notification based on the information associated with the context; and
cause the network interface to transmit the notification to the device based on the determination.

13. The computing system of claim 12, wherein the network interface is to transmit data to and receive data from the device through a cloud computing system.

14. The computing system of claim 12, wherein the notification provision module is to identify the notification based on information received through the network interface from a remote server.

15. The computing system of claim 12, wherein the notification is to indicate one of an alert or a task to be performed.

16. The computing system of claim 15, wherein the notification provision module is further to process a result associated with the task and received through the network interface from the device.

17. The computing system of claim 12, wherein the information received by the notification provision module comprises a Boolean value, and the notification provision module is to determine whether the device is to be provided the notification based on the Boolean value.

18. The computing system of claim 12, wherein the information received by the notification provision module comprises a percentage value, and the notification provision module is to determine whether the device is to be provided the notification based the percentage value.

19. The computing system of claim 12, wherein the information received by the notification provision module comprises information associated with at least one of a sensor of the device or an application of the device, and the notification provision module is to determine whether the device is to be provided the notification based the information associated with the at least one of the sensor or the application.

20. One or more non-transitory computer-readable media comprising executable instructions, wherein the instructions, in response to execution by a computer system, cause the computer system to:
detect contextual information associated with one or more of a sensor or an application of a device;
determine an indication of whether the device is to be provided a notification based on the contextual information; and
transmit, to a remote server, the indication of whether the device is to be provided the notification.

21. The one or more non-transitory computer-readable media of claim 20, wherein to determine comprises to determine whether the device is to be provided with a notification that indicates one of an alert or a task associated with the device.

22. The one or more non-transitory computer-readable media of claim 20, wherein to transmit comprises to transmit an indication that comprises one of a value or the contextual information.

23. A computer-implemented method comprising:
receiving, by a computer, information associated with a context of a device;
identifying, by the computer, whether the device is to be provided a notification based on the information; and
transmitting, by the computer, the notification to the device based on the identifying.

24. The method of claim 23, wherein identifying comprises identifying a notification to indicate one of an alert or a task associated with the device.

25. The method of claim 23, wherein receiving comprises receiving information having one of a value or information associated with a context of the device.
